(19) United States
(12) Patent Application Publication
(10) Pub. No.: US 2002/0119300 A1
(43) Pub. Date: Aug. 29, 2002

(54) Breathable and elastic polyurethane films and laminates containing same

(76) Inventor: Jack D. Taylor, Roswell, GA (US)

Correspondence Address: TIMOTHY A. CASSIDY, Dority & Manning, Attorneys at Law, P.A., P.O. Box 1449, Greenville, SC, 29602, US

(21) Appl. No.: 09/998,001

(22) Filed: Nov. 29, 2001

Related U.S. Application Data
(60) Provisional application No. 60/257,987, filed on Dec. 22, 2000.

(51) Int. Cl. B29C 55/06; B29C 67/20

(52) U.S. Cl. 428/312.8; 264/154; 264/210.5; 264/210.6; 428/315.5; 428/315.9

(57) ABSTRACT

An elastic breathable film is disclosed. The film is formed from a thermoplastic elastomer that contains a filler. Once the film is formed, the film is stretched causing the formation of micropores. The thermoplastic elastomer then undergoes phase separation between hard segment blocks and soft segment blocks which restores elasticity to the film. In one embodiment, the thermoplastic elastomer is a thermoplastic polyurethane elastomer.

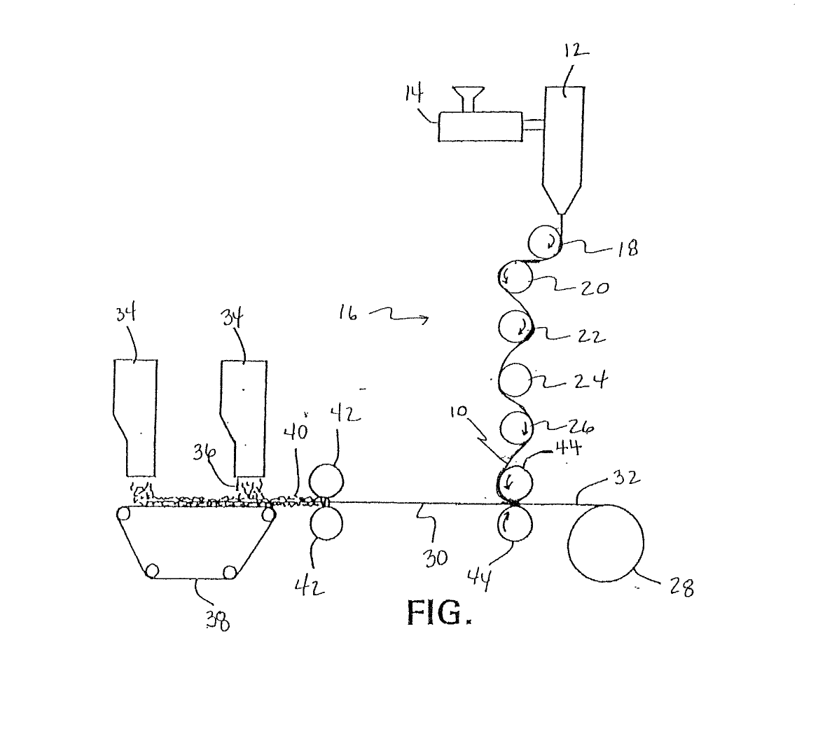

### RELATED APPLICATIONS

The present application is based on a Provisional Application having U.S. application Ser. No. 60/257,987 filed on Dec. 22, 2000.

### BACKGROUND OF THE INVENTION

There exists a variety of fabrics today which are capable of acting as a barrier to particulate matter, water and other liquids yet which allow water vapor and air to pass therethrough. Such fabrics are commonly referred to as “breathable barriers.” Breathable barrier fabrics have been employed in outdoor fabrics, tarpaulins, garments, personal care products, infection control products, as well as in numerous other articles. Moreover breathable barrier fabrics are often preferred over non-breathable barrier materials since breathable barrier fabrics allow moisture trapped beneath the fabric to escape as water vapor. Thus, apparel using breathable barrier fabrics is generally more comfortable to wear since the migration of water vapor through the fabric helps to reduce and/or eliminate discomfort resulting from excess moisture trapped against the skin.

While a variety of breathable barrier fabrics are known in the art, one particularly useful breathable barrier comprises stretched filled microporous films. Such films are typically filled with particles or other matter and then crushed or stretched to form a fine pore network which creates tortuous paths through the film. The film pore network allows gas and water vapor to pass through the film while acting as a barrier to liquids and particulate matter. The amount of filler within the film and the degree of stretching is controlled so as to create a network of micropores of a size and/or frequency to impart the desired level of breathability to the fabric.

Exemplary stretched films are described in U.S. Pat. Nos. 5,695,868; 6,015,764; 6,045,900; and 6,111,163, which are all incorporated herein by reference.

Although the above cited patents have provided great advancements in the art, a need still remains for improved breathable barrier films and processes for producing the films. A need also exists for improved breathable barrier laminates which exhibit good breathability and barrier properties.

### SUMMARY OF THE INVENTION

In general, the present invention is directed to elastic films, laminates containing the films, and to a process for forming the films and laminates. The elastic film of the present invention is made from a thermoplastic elastomer, such as a thermoplastic polyurethane elastomer.

For example, in one embodiment, the elastic film includes a microporous film layer made from a thermoplastic polyurethane elastomer containing a filler. The thermoplastic polyurethane elastomer can include hard segments and soft segments. The film layer can have an original length and a stretched length. In particular, the film layer is stretched and has a permanent elongation of at least 2 times its original length thereby forming micropores adjacent to the filler particles for providing breathability.

In accordance with the present invention, a thermoplastic elastomer is chosen that undergoes phase separation between the soft segments and the hard segments after the film layer has been stretched. Phase separation occurring after stretching provides the film with elastic properties. For example, the film layer can have an WVTR of at least 1000 g/m²-24hrs, and particularly can have an WVTR of at least 2000 g/m²-24hrs.

The thermoplastic polyurethane elastomer used in the present invention can be either an ether-based polyurethane or an ester-based polyurethane. The film layer can contain the filler in an amount of at least 20% by volume, and particularly in an amount of at least 30% by volume. In general, any suitable filler can be used. Examples of fillers include calcium carbonate and barium sulfate.

In one embodiment, the film layer made according to the present invention can have a final unbiased length in addition to its original length and the stretched length. In this embodiment, after the film layer is stretched from its original length to the stretched length, the film layer is relaxed to the final unbiased length. The final unbiased length is at least 2 times the original length. Once the final unbiased length is reached, the thermoplastic polyurethane elastomer undergoes phase separation. In general, the stretched length can be from about 4 times to about 7 times the original length, while the final unbiased length can be from about 3 times to about 5 times the original length.

Once formed, and after phase separation has occurred, the film is elastic such that, upon application of a force, it is stretchable to a biased length of at least 133% of its relaxed length and will recover at least 50% of its elongation upon release of the force.

The basis weight of the film can vary depending upon the particular application. For instance, in one embodiment, the film can have a final basis weight of less than about 50 gsm and particularly less than about 10 gsm.

The film can be used in various and numerous applications. For example, the film can be bonded to a support layer in order to form a laminate. The support layer can be, in one embodiment, an extensible or gatherable non-woven web, such as an extensible or gatherable spunbond web. The resulting laminate can then be used to construct various articles, such as a personal care article.

In order to form an elastic film of the present invention, in one embodiment, a film is formed from a thermoplastic polyurethane elastomer. The film can be formed, for instance, through an extrusion process. The thermoplastic polyurethane elastomer can be a block polymer containing hard segments and soft segments. Besides containing a thermoplastic elastomer, the film can also contain a filler. Once the film is formed, the film is then stretched in an amount sufficient for micropores to form. After stretching, the film is cured in a stretched state. During curing, the thermoplastic polyurethane elastomer undergoes phase separation between the hard segments and soft segments.

Other features and aspects of the present invention are discussed in greater detail below.

Definitions

As used herein the term “meltblown fibers” means fibers of a polymeric material which are generally formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter. Thereafter, the meltblown fibers can be carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers may be continuous or discontinuous, are generally smaller than 10 microns in average diameter, and are generally tacky when deposited onto a collecting surface.

As used herein, the term “neck-bonded laminate” refers to an elastic member being bonded to a non-elastic member while the non-elastic member is extended in the machine direction creating a necked material. The non-elastic member can be creped in one or two directions. “Neck-bonded laminate” refers to a composite material having at least two layers in which one layer is a necked, non-elastic layer and the other layer is an elastic layer thereby creating a material that is elastic in the cross direction. Examples of neck-bonded laminates are such as those described in U.S. Pat. Nos. 5,226,992, 4,981,747, 4,965,122, and 5,336,545, all to Morman, all of which are incorporated herein by reference thereto.

As used herein the term “personal care product” means diapers, training pants, absorbent underpants, adult incontinence products, and feminine hygiene products.

As used herein the term “spunbond fibers” refers to small diameter fibers of a molecularly oriented polymeric material. Spunbond fibers may be formed by extruding a molten thermoplastic material as filaments from a plurality of fine, usually circular capillaries of a spinneret with the diameter of the extruded filaments then being rapidly reduced as by, for example, in U.S. Pat. No. 4,340,563 to Appel et al., U.S. Pat. No. 3,692,618 to Dorschner et al, U.S. Pat. No. 3,802,817 to Matsuki et al., U.S. Pat. Nos. 3,338,992 and 3,341,894 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having and average fiber diameter less than about 10 microns) may be achieved by various methods.

As used herein, the term “stretch-bonded laminate” refers to a composite material having at least two layers in which one layer is a non-elastic gatherable layer and the other layer is an elastic layer. The layers are joined together when the elastic layer is in an extended condition so that upon relaxing the layers, the gatherable layer is gathered. For example, one elastic member can be bonded to another member while the elastic member is extended at least about 25 percent of its relaxed length. Such a multilayer composite elastic material may be stretched until the non-elastic layer is fully extended. One type of stretch-bonded laminate is disclosed, for example, in U.S. Pat. No. 4,720,415 to Vander Wielen et al., which is incorporated herein by reference. Other composite elastic materials are described and disclosed in U.S. Pat. Nos. 4,789,699 to Keiffer et al., 4,781,966 to Taylor, 4,657,802 to Morman, and 4,655,760 to Morman et al., all of which are incorporated herein by reference thereto.

As used herein, the phrase “Water Vapor Transmission Rate” (WVTR) is determined according to the test procedure standardized by INDA (Association of the Nonwoven Fabrics Industry), number IST-70.4-99, (known to those skilled in the art) which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W model 100K manufactured Mocon/Modern Controls, Inc, Minneapolis, Minn.

A first test is made of the WVTR of the guard film and the air gap between an evaporator assembly that generates 100% relative humidity. Water vapor diffuses through the air gap and the guard film and then mixes with a dry gas flow which is proportional to water vapor concentration. A sensor generates a signal proportional to the vapor content of the gas stream. The electrical signal is routed to a computer for processing. The computer calculates the transmission rate of the air gap and guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. The computer then calculates the transmission rate of the combination of the air gap, the guard film, and the test material. This information is then used to calculate the rate at which moisture is transmitted through the test material according to the equation:

TR⁻¹_{test material}TR⁻¹_{test material,,guardfilm,airgap}−TR⁻¹_{guardfilm,airgap}

Calculations:

WVTR: The calculation of the WVTR uses the formula:

WVTR=Fpₛₐₜ(T)RH/Apₛₐₜ(T) (1−RH)

where:

F=The flow of water vapor in cc/min.,

Pₛₐₜ(T)=The density of water in saturated air at temperature T,

RH=The relative humidity at specified locations in the cell,

A=The cross sectional area of the cell, and,

Pₛₐₜ(T)=The saturation vapor pressure of water vapor at temperature, T.

### BRIEF DESCRIPTION OF THE DRAWINGS

A full and enabling disclosure of the present invention, including the best mode thereof to one of ordinary skill in the art, is set forth more particularly in the remainder of the specification, including reference to the accompanying figure in which:

The figure is a schematic diagram of a process line for making elastic films and laminates of the present invention.

Repeated use of reference characters in the present specification and drawings is intended to represent same or analogous features or elements of the present invention.

### DETAILED DESCRIPTION OF PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents.

The present invention is generally directed to filled microporous elastic films and laminates thereof. In accordance with the present invention, the microporous elastic films are made from thermoplastic elastomers, namely polyurethane elastomers.

In general, the films are formed by combining a filler with the polyurethane polymer. The mixture is then formed into a film through any suitable process, such as an extrusion process. Once the film is formed, the film is then stretched usually in the machine direction. During stretching, micropores form in the film adjacent to the filler particles. Once stretched, the film is then cured, which causes a recovery in the elastic properties of the polymer.

Polyurethane films made according to the present invention offer various benefits and advantages. For instance, the films are breathable while remaining substantially impervious to liquids, such as water. As used herein, the term “breathable” means that the film is pervious to water vapor and gases. One measure of breathability is determining the water vapor transmission rate (WVTR) of the film. Films made according to the present invention can have a WVTR of at least 300 g/m²-24 hours, particularly at least about 1000 g/m²-24 hours, and in some embodiments may have a WVTR of at least 2000 g/m²-24 hours.

In addition to being breathable, polyurethane films made according to the present invention are also elastic. Of particular advantage, polyurethane films made according to the present invention are not only elastic in the machine direction, but also in the cross machine direction. For instance, the films, upon application of a biasing force, are stretchable, that is, elongatable, to a stretched, biased length which is at least 133%, particularly 150%, of its relaxed unbiased length. Further, the films will recover at least 50% of their elongation upon release of the stretching, elongating force.

As described above, the polyurethane polymer used in the present invention is a thermoplastic polymer, and particularly a thermoplastic elastomer. A thermoplastic polymer is capable of softening or fusing when heated and of hardening again when cooled. A thermoplastic elastomer on the other hand, is a rubbery material with the heat and fabrication characteristics of a conventional thermoplastic and the performance properties of a conventional thermoset rubber.

In general, polyurethanes are polymers containing a plurality of carbamate linkages, and are commonly formed by reacting a polyisocyanate with an organic polyhydroxy material or polyol. The thermoplastic polyurethane elastomers used in the present invention are multi-block polymers. One type of block are hard segment blocks which act as multifunctional tie points functioning both as physical cross-links and reinforcing fillers. The other type of blocks are soft segment blocks which can be long flexible polymer chains which interconnect to hard segments. The soft segments form an elastomer matrix which accounts for the elastic properties of the thermoplastic polyurethane elastomer.

At room temperature, the low melting soft segments are incompatible with the polar high melting hard segments, which causes microphase separation. A part of the driving force for phase separation is a development of the crystallinity of the hard segments. Upon heating above the melting temperature of the hard segments, the polymer forms a homogenous viscous melt which can be processed by thermoplastic techniques, such as extrusion, blowmolding, etc. Subsequent cooling, however, leads again to segregation of the hard and soft segments.

The properties of thermoplastic polyurethane elastomers are strongly affected by hard and soft segment domain morphology (structure or form). The hard and soft phase separation of thermoplastic polyurethane elastomers has been shown to be time-dependent, because of their high viscosities. In particular, the mechanical elastic properties of thermoplastic polyurethane elastomers are strongly related to the time-dependent formation of domain morphology. Therefore, post curing of a thermoplastic polyurethane elastomer after thermoformation can be done in order to obtain optimal properties.

Many elastomer materials undergo phase separation upon cooling very rapidly. The present inventor, however, has discovered that when forming filler filled microporous films from polyurethane elastomers, the elastic properties of the film can be improved when selecting a polyurethane elastomer that requires a relatively long amount of time to undergo phase separation or cure. More specifically, the present invention is directed to the use of thermoplastic polyurethane elastomers that can be filled with a filler, formed into a film, stretched to form micropores, and thereafter cured when a substantial portion or most of the phase separation occurs.

In particular, once a filled film is produced and drawn, the drawn film will have little, if any, tendency to recover in the direction opposite to the direction that it was drawn, resulting in a film having inferior elastic properties. Choosing a polyurethane polymer that will undergo phase separation after the film is drawn, however, allows the film to recover a substantial amount of elasticity that would otherwise be lost.

The amount of time needed for phase separation to occur in a thermoplastic polyurethane elastomer processed according to the present invention will depend upon the particular process conditions and the amount of time needed to form and stretch the filler filled film. For most applications, however, a thermoplastic polyurethane elastomer should be chosen that requires at least 1 hour, and particularly at least 24 hours, before a substantial amount of phase separation occurs.

As stated above, the time it takes for phase separation to occur is generally a function of domain morphology. When using thermoplastic polyurethane elastomers according to the present invention, it is believed that the higher the viscosity of the polymer, the longer it will take for phase separation to occur. Similarly, it is believed that using polymers with higher molecular weights will also increase the phase separation time. For example, the polymer can have a molecular weight grater than 50,000 g/mol, particularly greater than 100,000 g/mol and more particularly greater than 120,000 g/mol.

In general, suitable thermoplastic polyurethane elastomers that may be used in the process of the present invention include three components, namely a diisocyanate component, a short chain diol component and a long chain diol component. The short chain diol component can be, for instance, butanediol.

Examples of thermoplastic polyurethane elastomers that may be used in the present invention include ether-based polyurethanes and ester-based polyurethanes. For instance, such polyurethane elastomeric materials are commercially available under the trademark ESTANE from B. F. Goodrich & Co. or under the trademark MORTHANE from Rohm & Haas. A particular example of a polyester-based aromatic thermoplastic polyurethane is MORTHANE PS 370-200 RESIN available from Rohm & Haas and a particular polyether-based aromatic thermoplastic polyurethane is MORTHANE PE 90-200 also available from Rohm & Haas Company.

In order to cure or allow phase separation to occur in films made from the above polyurethane polymers after the films have been stretched generally requires no special processing criteria absent allowing enough time to pass for the films to recover some elasticity. For example, once the films have been formed and stretched, the films can simply be stored at ambient temperatures for about one day to about two weeks, depending upon the polyurethane polymer that is used. Ambient temperatures, for instance, can be at a temperature of from about 50° F. to about 100° F.

If desired, curing can occur at an elevated temperature for a shorter period of time. For example, the stretched film can be cured at a temperature of from about 100° F. to about 150° F. It should be understood, however, that the respective post curing conditions will vary depending upon the thermoplastic polyurethane elastomer that is used.

One particular advantage to using thermoplastic polyurethane elastomers that undergo phase separation slowly is that phase separation will occur in a multidirectional orientation. For example, when using an elastomer that undergoes phase separation rapidly, most phase separation will occur during stretching which will cause the soft segments and hard segments to orient in the direction in which the film is stretched. When phase separation occurs more slowly, however, the soft segments and hard segments will have a greater tendency to orient randomly. Thus, films made in accordance with the present invention have improved elastic properties in the direction opposite to which the film is stretched, such as in the cross machine direction and/or in a direction diagonal to the cross machine direction.

As described above, a filler is added to the thermoplastic polyurethane elastomer in order to impart breathability upon stretching. As used herein, a “filler” is meant to include particles and/or other forms of materials which can be added to the polymer which will not chemically interfere with or adversely affect the extruded film and further which can be uniformly dispersed throughout the film. Generally, the fillers will be in particulate form with average particle sizes in the range of from about 0.1 to about 10 microns, desirably from about 0.1 to about 4 microns. As used herein, the term “particle size” describes the largest dimension or length of the filler.

In general, any suitable filler may be used in the present invention. Both organic and inorganic fillers are contemplated provided they do not interfere with the film forming process and/or subsequent laminating processes. Examples of fillers include calcium carbonate, various clays, silica, alumina, barium sulfate, talc, magnesium sulfate, zeolites, aluminum sulfate, cellulose-type powders, diatomaceous earth, gypsum, magnesium sulfate, magnesium carbonate, barium carbonate, kaolin, mica, carbon, magnesium oxide, aluminum hydroxide, pulp powder, wood powder, cellulose derivatives, polymeric particles, chitin and chitin derivatives. The filler particles may optionally be coated with a fatty acid, such as stearic acid or behenic acid, and/or other materials in order to facilitate the free flow of the particles and their ease of dispersion into the polymer.

The amount of filler added to the polymer will depend upon the particular application. For most applications, however, the filler should be added to the polymer in an amount of at least 20% by volume of the resulting film, and particularly from about 30% to about 40% by volume. Within the above parameters, the filler can be added to the polymer in an amount of at least about 35% by weight, and particularly from about 45% to about 65% by weight.

Besides a filler, various other additives can be added to the polymer. For example, one or more stabilizers or film forming additives can be present within the mixture. Stabilizers can include melt stabilizers, processing stabilizers, heat stabilizers, light stabilizers, heat ageing stabilizers, and the like.

The basis weight of films made according to the present invention can also vary. For instance, the stretched film can have a basis weight of less than about 100 gsm, and particularly less than about 60 gsm. For most embodiments, the final film will have a basis weight of less than about 15 gsm, and particularly less than about 10 gsm. At these basis weights, the film will have a thickness of less than about 30 microns, and particularly less than about 15 microns.

Breathable elastic films made according to the present invention can be used in a wide variety of applications. The film can be used alone or in combination with other layers to form a laminate. For example, the film can be bonded to a support layer and used as desired.

When used as a laminate, the support layer can be any material capable of being laminated to the film. In one embodiment, the support layer can be a breathable fibrous layer. The fibrous layer may include, as an example, non-woven webs, multilayered non-woven laminates, scrims, woven fabrics, and/or other like materials. In one embodiment, the support fabric can be one or more layers of spunbonded or meltblown fiber webs.

For instance, the support layer can be a necked polypropylene spunbond layer to form a neckbonded laminate. The support layer can also be a spunbond or meltblown web to form a stretchbonded laminate.

A plurality of support layers may also be used. Examples of such materials can include, for example, spundbond/meltblown laminates and spunbond/meltblown/spunbond laminates, such as are taught in Brock et al, U.S. Pat. No. 4,041,203, which is incorporated herein by reference in its entirety.

The barrier laminates of the present invention may be used to construct various articles and can be used in various products. For instance, the barrier laminates can be used as a component of protective covers, and infection control products, personal care products, garments and other articles that desirably have barrier properties and breathability. As examples thereof, the barrier laminates may be used to construct a diaper, an adult incontinence garment or a surgical gown.

The manner in which the breathable elastic film of the present invention is bonded to a support layer can vary. For example, the layers can be bonded together using thermobonding such as thermopoint bonding. Other bonding techniques include the use of an adhesive, ultrasonic bonding, the use of a bonding agent contained in the film or the support layer, and the like.

Referring to the figure, a schematic diagram of a process line for fabricating breathable elastic films and laminates of the present invention is shown. As illustrated, a film 10 is formed from an extrusion film apparatus 12 such as a cast or blown unit. The apparatus 12 includes a single extruder 14. It should be understood, however, that two or more polymer extruders may be used.

From the extrusion film apparatus 12, the unstretched film 10 is directed to a film stretching unit generally 16, such as a machine direction orienter which may be a commercially available device from various vendors such as the Marshall & Williams Company of Providence, Rhode Island. The film stretching unit 16 has a plurality of rollers which stretch and thin the unstretched film 10 in the machine direction of the film which is the direction of travel of the film through the process. The rollers can be at ambient temperature or either cooled or heated depending on the particular application. Within the film stretching unit 16, the film can be stretched in either a single or multiple stretching operation.

As shown in the figure, the unstretched extruded film is first contacted with a first driven chilled roll 18. From driven chilled roll 18, the film is guided around a driven chilled roll 20. In order to stretch the film, driven chilled roll 20 can travel at a circumferential speed faster than that of roll 18. The different speeds of the adjacent rollers act to stretch the film 10.

From driven chilled roll 20, the film is guided around a third driven roll 22 which can also be traveling at a faster speed than roll 20 for further stretching the film.

In this embodiment, from third driven roll 22, the film is guided around an idle roll 24 and subsequently around a driven roll 26. Driven roll 26 can be traveling at a faster circumferential speed than third driven roll 22 for further stretching the film and ensuring the formation of micropores.

Rolls 18, 20, 22, and 26 if desired can all be chilled in order to decrease the temperature of the film and prepare the film for phase separation. From the driven roll 26, the film 10 is passed between nip rolls 44. Nip rolls 44 can be traveling with the same surface speed or a different surface speed than that of driven roll 26 depending upon the particular circumstances and desired result. From the nip rolls 44, film 10 is ultimately wound on a winding roll 28. Winding roll 28 can travel at the same speed or at a different speed than nip rolls 44 again depending upon the particular circumstances and the desired result.

In order to prevent the film 10 from sticking to itself, the film can be wound with a support layer and stored on winding roll 28. Alternatively, the film 10 can be attached to one or more outer layers, such as a fibrous layer 30, to form a film/non-woven laminate 32. In one embodiment, a conventional non-woven web forming apparatus 34, such as a pair of spunbond machines can be used to form the outer fibrous layer 30. The long, essentially continuous spunbond fibers 36 are deposited onto a forming wire 38 as an unbonded web 40 and may then be sent through a pair of compaction and/or bonding rolls 42 to add sufficient integrity to the web for further processing.

Once the film 10 has been sufficiently thinned and the fibrous layer 30 has been formed, the two layers can be brought together and bonded such as pointbonded, to one another using a bonder, such as a pair or nip rolls 44. The nip rolls 44 can be heated if desired. Once the laminate 32 exits the bonding or nip rolls 44, it may be wound up onto the winding roll 28.

The process shown in the figure may also be used to create laminates having more than two layers. For example, a second fibrous layer can be laminated to the opposite side of the film 10 if desired.

When using a thermoplastic polyurethane elastomer of the present invention, the film 10 should be stretched within the film stretching unit 16 at least two times its original length prior to phase separation of the polymer. For most applications, the film should be stretched three times its original length and particularly from about four times to about seven times its original length. Stretching the film within the above ranges allows for the formation of micropores making the film breathable, while allowing the film to retain elasticity, especially after phase separation occurs.

In one embodiment, the polyurethane elastomer film is first stretched to form micropores and then partially relaxed to a final, unbiased length prior to phase separation. For example, in this embodiment, the film can be stretched in the film stretching unit 16 and then partially relaxed by decreasing the speed of the winding roll 28 in relation to the nip rolls 44. After being relaxed, the film can then be cured by allowing phase separation to occur. For example, in one embodiment, the film can be stretched from about 3 times to about 7 times its original length on driven chilled roll 18 and then relaxed by the winding roll 28 so that the final length of the film is at least 2 times its original length, and particularly from about 3 times to about 5 times its original length. By stretching the film and then partially relaxing the film, it has been discovered that the elastic properties of the film can be optimized while still remaining breathable.

The present invention may be better understood with reference to the following examples.

### EXAMPLE 1

Various polyurethane elastomer films were produced and tested for various properties. Some of the films contained a filler, while other films did not. The film samples were produced on a system similar to that shown in the figure. As the films were extruded, the films were stretched and wound. In some examples, the films were partially relaxed after being stretched prior to being wound.

When the formed film was wound, the film was placed on a spunbond polypropylene layer in order to prevent the film from sticking to itself. In some examples, the film was actually laminated to a facing layer. In these examples the layer was laminated to a facing layer that was itself extensible in both the machine direction (MD) and cross machine direction (CD). This two-way extensible facing was a 1.1 osy 60% CD necked and 60% MD creped spunbond polypropylene layer that was itself extensible 150% in the MD and 150% in the CD. The film was bonded to the spunbonded fabric using an adhesive which was applied in between the two layers at an amount of 4 gsm.

The extruder was heated to a temperature ranging from about 328° F. to about 371° F. during formation of the film. Once formed, the film was cooled using chilled rolls as described above in relation to the figure.

Films were produced from a thermoplastic ether-based polyurethane elastomer and from a thermoplastic ester-based polyurethane elastomer. The ether-base polyurethane used was MORTHANE PE90-200 resin obtained from Rohm & Haas Co. The ester-based polyurethane, on the other hand, was MORTHANE PS370-200 also obtained from the Rohm & Haas Co. The filler added to the films was either barium sulfate or calcium carbonate. The barium sulfate used was obtained from Davis Chemical Corp. of Inglewood Cliffs, N.J. The calcium carbonate used in the examples, on the other hand, was obtained from ECC International of Roswell, Georgia.

The following films were formed:

TABLE 1

| | | | | Max. | Final | | |
|---|---|---|---|---|---|---|---|
| Film | | | Vol | Stretch | Stretch | Basis | |
| Sample | Polyurethane | Filler (amount) | % | Ratio | Ratio | Weight | Laminate |
| 1 | ether-based | — | — | 6.1 | 3.5 | 10 | No |
| 2 | ether-based | BaSO₄ (52 wt %) | 21 | 5.0 | 3.8 | 8 | No |
| 3 | ether-based | BaSO₄ (52 wt %) | 21 | 5.0 | 3.6 | 8-11 | Yes |
| 4 | ether-based | BaSO₄ (52 wt %) | 21 | 1.1 | 1.3 | 19 | No |
| 5 | ether-based | BaSO₄ (52 wt %) | 21 | 6.0 | <6.0 | — | Yes |
| 6 | ester-based | — | — | 1.1 | 1.1 | 8 | Yes |
| 7 | ester-based | CaSO₃ (50 wt %) | 31 | 5.1 | 3.5 | 9 | Yes |
| 8 | ester-based | CaSO₃ (50 wt %) | 31 | 5.1 | 3.5 | 9 | No |
| 9 | ester-based | CaSO₃ (50 wt %) | 31 | 6.0 | 3.6 | 9 | Yes |
| 10 | ester-based | CaSO₃ (50 wt %) | 31 | 6.0 | 3.6 | 9 | No |
| 11 | ester-based | CaSO₃ (50 wt %) | 31 | 1.0 | 1.0 | 20 | No |
| 12 | ester-based | — | — | 6.1 | 4.0 | 15 | No |

After the above films were formed, the films were stored at ambient temperatures for at least 2 weeks.

The above films were then tested for various properties including MOCON WVTR, Hydrohead, and elasticity in the machine direction and in the cross machine direction. MOCON WVTR was calculated according to the procedure described in the Definition section above.

Hydrohead is a test to measure the liquid barrier properties of a layer. The hydrohead test determines the height of water (in cm) which the fabric will support before a predetermined amount of liquid passes through. A fabric with a higher hydrohead reading indicates it has a greater barrier to liquid penetration than a fabric with a lower hydrohead. The hydrohead test was performed according to Federal Test Standard 191A, Method 5514.

In order to measure elasticity, a 3″×7″ sample size of the film was placed in between a pair of opposing grips and stretched to 2 times its original length. The stretching apparatus that can be used could be a SINTECH Model 1/5 or Model 2/5 commercially available from the SINTECH division of MTS Systems Corp. of Research Triangle Park, N.C.

Each sample was stretched to 2 times its original length for three cycles. During the first cycle, the tension “in grams” was recorded during extension at 30% and at 50%. During the second cycle, the tension was measured during retraction at 50% and at 30%. The first extension at 50% and the second retraction at 50% was then used to calculate hysteresis as a percent tension drop. More particularly, hysteresis was calculated by subtracting the retraction tension from the loading tension and then dividing by the loading tension. During the third cycle, the film was stretched until failure occurred.

The following results were obtained:

TABLE 2
Properties of Produced films including Machine Direction Stretch
Values

| | WVTR | | MD 30% | MD 50% | MD 50% | MD 30% | % | |
|---|---|---|---|---|---|---|---|---|
| Sample | (g/m²- | Hydro | Ext. | Ext. | Ret. | Ret. | Stretch | Hysteresis |
| No. | 24 hrs) | head | Tension | Tension | Tension | Tension | at Break | % |
| 1 | 4253 | — | 333 | 590 | 193 | 105 | 248 | 67 |
| 2 | 7191 | 98 | 280 | 694 | 66 | 28 | 120 | 90 |
| 3 | 5150 | 151 | 540 | 850 | 66 | 6 | >150 | 92 |
| 4 | 3100 | 144 | 342 | 373 | 85 | 26 | >400 | 77 |
| 5 | 4765 | 123 | 391 | 609 | 93 | 23 | >200 | 85 |
| 6 | 3633 | 157 | 410 | 679 | 57 | 17 | 156 | 92 |
| 7 | 2541 | 157 | 532 | 815 | 44 | 2 | >150 | 95 |
| 8 | 2522 | 170 | 345 | 461 | 42 | 19 | 152 | 91 |
| 9 | 2728 | 160 | 466 | 711 | 52 | 5 | >160 | 93 |
| 10 | 3484 | 141 | 256 | 362 | 62 | 30 | 153 | 83 |
| 11 | 1468 | 94 | 335 | 352 | 68 | 25 | 390 | 81 |
| 12 | 1316 | — | 197 | 312 | 197 | 122 | 270 | 37 |

TABLE 3
Cross Machine Direction Stretch Values

| | CD | CD | CD | CD | | |
|---|---|---|---|---|---|---|
| Sample | 30% Ext. | 50% Ext. | 50% Ret. | 30% Ret. | % Stretch at Break | Hysteresis |
| No. | Tension | Tension | Tension | Tension | Break | (%) |
| 1 | 171 | 196 | 73 | 35 | >500 | 63 |
| 2 | 111 | 119 | 21 | 3 | >500 | 82 |
| 3 | 341 | 445 | 8 | 0 | 200 | 98 |
| 4 | 339 | 369 | 82 | 22 | 426 | 78 |
| 5 | 331 | 433 | 13 | 0 | 206 | 97 |
| 6 | 280 | 387 | 54 | 17 | 225 | 86 |
| 7 | 382 | 497 | 19 | 0.4 | 206 | 96 |
| 8 | 144 | 154 | 29 | 11 | >400 | 81 |
| 9 | 344 | 450 | 16 | 0 | 190 | 96 |
| 10 | 108 | 115 | 21 | 8 | >350 | 82 |
| 11 | 313 | 327 | 62 | 25 | >350 | 81 |
| 12 | 152 | 207 | 115 | 72 | 498 | 44 |

As shown in Tables 2 and 3 above, this example demonstrates that films can be made from polyurethane polymers that have good breathability properties and good elastic properties.

### EXAMPLE 2

Further samples of films were made in accordance with the present invention. The films were formed according to the procedures described in Example 1. In this example, however, only the ether-based polyurethane was used and none of the films were laminated to a support layer. During extrusion, the extruder was heated to a temperature of from about 340° F. to about 350° F. The following films were formed:

TABLE 4

| | | | Filler | MAX | Final | Basis |
|---|---|---|---|---|---|---|
| Film | | Filler | Vol. | Stretch | Stretch | Weight |
| Sample | Polyurethane | (Amount) | % | Ratio | Ratio | (gsm) |
| 13 | ether-based | CaCO₃ | 29 | 6.0 | 6.0 | 8.1 |
| | | (50%) | | | | |
| 14 | ether-based | CaCO₃ | 29 | 6.0 | 3.9 | 10.1 |
| | | (50%) | | | | |
| 15 | ether-based | CaCO₃ | 29 | 1.1 | 1.1 | 17.8 |
| | | (50%) | | | | |
| 16 | ether-based | CaCO₃ | 29 | 5.1 | 5.1 | 8.3 |
| | | (50%) | | | | |
| 17 | ether-based | CaCO₃ | 29 | 5.1 | 3.3 | 9.5 |
| | | (50%) | | | | |
| 18 | ether-based | BaSO₄ | 24 | 1.1 | 1.1 | 16.8 |
| | | (55%) | | | | |

After the films were formed and stored, the films were then tested for breathability and elasticity. The following results were obtained:

TABLE 5
Properties of produced films including Machine
Direction Stretch Values

| | | | | MD | | |
|---|---|---|---|---|---|---|
| | WVTR | | MD | 50% | % | |
| Sample | (g/m²- | Hydro | 50% Ext. | Ret. | Stretch | Hysteresis |
| No. | 24 hrs) | head | Tension | Tension | at Break | (%) |
| 13 | 6448 | 95 | 324 | 55 | 114 | 35 |
| 14 | 4934 | 133 | 354 | 45 | 105 | 34 |
| 15 | 2082 | 134 | 322 | 70 | 345 | 45 |
| 16 | 6877 | 142 | 347 | 38 | 106 | 36 |
| 17 | 5864 | 103 | 396 | 60 | 100 | 38 |
| 18 | 3544 | 82 | 296 | 62 | 398 | 48 |

TABLE 6
Cross Machine Direction Stretch Values

| | CD | CD | | |
|---|---|---|---|---|
| | 50% Ret. | 50% Ret. | % Stretch at | Hysteresis |
| Sample No. | Tension | Tension | Break | (%) |
| 13 | 78 | 14 | >400 | 47 |
| 14 | 78 | 16 | >400 | 44 |
| 15 | 304 | 61 | >300 | 44 |
| 16 | 72 | 14 | >400 | 44 |
| 17 | 93 | 18 | >400 | 44 |
| 18 | 291 | — | <100 | — |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. An elastic film comprising:
a microporous film layer comprising a thermoplastic polyurethane elastomer and a filler, said thermoplastic polyurethane elastomer comprising hard segments and soft segments, said film layer having an original length and a stretched length, said film layer having been stretched and having a permanent elongation of at least two times its original length thereby forming micropores adjacent filler particles;
said thermoplastic polyurethane elastomer undergoing phase separation between said soft segments and said hard segments after said film layer has been stretched, said film layer having an WTVR of at least 1000 g/m²-24 hours.

2. An elastic film as described in claim 1, wherein said microporous film layer is elastic such that, upon application of a force is stretchable to a biased length of at least 133% of its relaxed length and will recover at least 50% of its elongation upon release of said force.

3. An elastic film as defined in claim 1, wherein said thermoplastic polyurethane elastomer comprises an ether-based polyurethane.

4. An elastic film as defined in claim 1, wherein said thermoplastic polyurethane elastomer comprises an ester-based polyurethane.

5. An elastic film as defined in claim 1, wherein said film layer contains said filler in an amount of at least 20% by volume.

6. An elastic film as defined in claim 1, wherein said film layer contains said filler in an amount of at least 30% by volume.

7. An elastic film as defined in claim 1, wherein said film layer has an WVTR of at least 2000 g/m²-24 hours.

8. An elastic film as defined in claim 1, wherein said filler comprises calcium carbonate, barium sulfate, or mixtures thereof.

9. An elastic film as defined in claim 1, wherein said film layer has a final unbiased length in addition to said original length and said stretched length, and wherein, after being stretched from its original length to the stretched length, said film layer is relaxed to said final unbiased length, said final unbiased length being at least two times the original length, said thermoplastic polyurethane elastomer undergoing phase separation after being relaxed to said final unbiased length.

10. An elastic film as defined in claim 9, wherein said stretched length is from about four times to about seven times the original length and said final unbiased length is from about three times to about five times the original length.

11. An elastic film as defined in claim 1, wherein said film layer has a basis weight of less than about 100 gsm.

12. An elastic film as defined in claim 1, wherein the thermoplastic polyurethane elastomer undergoes phase separation for at least 1 hour after having been stretched.

13. An elastic film as defined in claim 1, wherein the thermoplastic polyurethane elastomer undergoes phase separation for at least 24 hours after having been stretched.

14. An elastic film comprising:
a thermoplastic polyurethane elastomer layer containing a filler, said filler being present in an amount of at least 20% by volume, said film being stretched an amount sufficient to form micropores within said layer, said thermoplastic polyurethane elastomer comprising an ether-based polyurethane or an ester-based polyurethane.

15. An elastic film as defined in claim 14, wherein said thermoplastic polyurethane elastomer contains hard segments and soft segments and wherein phase separation between said soft segments and said hard segments has occurred after said film has been stretched.

16. An elastic film as defined in claim 15, wherein said film has been stretched at least four times its original length.

17. An elastic film as defined in claim 15, wherein said film has been stretched from about four times to about seven times its original length to a stretched length and then relaxed to a final unbiased length prior to a substantial amount of said phase separation occurring, said final unbiased length being at least two times said original length.

18. An elastic film as defined in claim 14, wherein said film has an WVTR of at least 2000g/m²-24 hours.

19. An elastic film as defined in claim 14, wherein said film is elastic such that, upon application of a force, is stretchable to a biased length of at least 133% of its relaxed length and will recover at least 50% of its elongation upon release of said force.

20. A process for producing an elastic film comprising the steps of:
forming a film from a thermoplastic polyurethane elastomer, said thermoplastic polyurethane elastomer containing hard segments and soft segments, said film further containing a filler;
stretching said film an amount sufficient for micropores to form; and
thereafter curing said film in a stretched state, wherein said thermoplastic polyurethane elastomer undergoes phase separation between said hard segments and said soft segments.

21. A process as defined in claim 20, wherein said cured film is elastic such that, upon application of a force, the film is stretchable to a biased length of at least 133% of its relaxed length and will recover at least 50% of its elongation upon release of said force.

22. A process as defined in claim 20, wherein said cured film has an WVTR of at least 1000 g/m²-24 hours.

23. A process as defined in claim 20, wherein said film is stretched at least three times its original length.

24. A process as defined in claim 20, wherein said film contains said filler in an amount of at least 20% by volume.

25. A process as defined in claim 20, wherein said thermoplastic polyurethane elastomer comprises an ether-based polyurethane.

26. A process as defined in claim 20, wherein said thermoplastic polyurethane elastomer comprises an ester-based polyurethane.

27. A process as defined in claim 20, wherein said film is formed by extrusion.

28. A process as defined in claim 20, further comprising the step of relaxing said film after stretching said film to an unbiased final length prior to curing, said unbiased final length being at least two times the original length of the film.

29. A process as defined in claim 28, wherein said film is stretched from about four times to about seven times its original length and said unbiased final length is from about three times to about five times its original length.

30. A process as defined in claim 20, wherein said film undergoes phase separation for at least 1 hour in the stretched state.

31. A process as defined in claim 20, wherein said film undergoes phase separation for at least 24 hours in the stretched state.

32. A laminate comprising:
an elastic film comprising a thermoplastic polyurethane elastomer containing a filler, said filler being present in an amount of at least 20% by volume, said film being stretched an amount sufficient to form micropores, said thermoplastic polyurethane elastomer comprising an ether-based polyurethane or an ester-based polyurethane; and
a support layer bonded to said elastic film.

33. A laminate as defined in claim 32, wherein said thermoplastic polyurethane elastomer contains hard segments and soft segments and wherein phase separation between said soft segments and said hard segments occurs after said film has been stretched.

34. A laminate as defined in claim 32, wherein said film has been stretched at least four times its original length.

35. A laminate as defined in claim 32, wherein said film has been stretched from about four times to about seven times its original length to a stretched length and then relaxed to a final unbiased length prior to a substantial amount of said phase separation occurring, said final unbiased length being at least two times said original length.

36. A laminate as defined in claim 32, wherein said film has an WVTR of at least 2000 g/m²-24 hours.

37. A laminate as defined in claim 32, wherein said film is elastic such that, upon application of a force, is stretchable to a biased length of at least 133% of its relaxed length and will recover at least 50% of its elongation upon release of said force.

38. A personal care article comprising the laminate of claim 32.

39. A laminate as defined in claim 33, wherein said laminate comprises a stretch-bonded laminate.

40. A laminate as defined in claim 33, wherein said laminate comprises a neck-bonded laminate.
